(19) United States
(12) Patent Application Publication
(10) Pub. No.: US 2022/0131895 A1
(43) Pub. Date: Apr. 28, 2022

(54) MULTI-LEVEL PROTECTION TO PREVENT ATTACK TESTING

(71) Applicant: Shopify Inc., Ottawa (CA)

(72) Inventor: Dennis HO, Rockcliffe (CA)

(21) Appl. No.: 17/082,506

(22) Filed: Oct. 28, 2020

(51) Int. Cl. H04L 29/06; G06Q 30/02; G06Q 30/00

(52) U.S. Cl. CPC H04L 63/1466; H04L 63/1433; G06Q 30/0223; G06Q 30/0222; G06Q 30/0225; G06Q 30/0185; G06Q 30/0235

(57) ABSTRACT

In systems and methods for multiple level bot detection in e-commerce platforms during flash sale events conducted by merchants having accounts with e-commerce platform, a computer applies a first bot detection algorithm to web traffic of a webpage hosting the online store that is conducting the online sales event. The computer determines whether an actor device is executing a bot to make purchases based on a first bot detection algorithm. When the computer identifies a type of triggering instruction, such as a predetermined time period, a user instruction, or a data condition, the computer then applies a second bot detection algorithm to the web traffic. The bot detection algorithms determine signal scores for the customer devices that originated the web traffic. If the signal scores for a customer device satisfy a detection threshold, the server determines the device is operated by a bot actor, rather than a human actor.

### TECHNICAL FIELD

This application relates generally to information security and, more particularly, to access control, and more particularly to applying multiple bot detection algorithms for traffic on a website in limiting access to the website by bots.

### BACKGROUND

Flash sales are a useful mechanism to drive Internet traffic to a site for a promotion or other potential transaction for a limited period of time or for a limited amount of inventory. Entities may use an algorithm (referred to as a “bot”) that resembles a human actor by programmatically making purchases from the site in order to hoard sales inventory during a flash sale, which may be undesirable to some sites/merchants/manufacturers. However, not all bots are unwanted. The bots may be used by paying customers that desire to buy in bulk. During the flash sales, bot developers may test and adapt their bot algorithms. Bot prevention mechanisms may become more susceptible to circumvention if exposed for too long to bot developers.

### BRIEF DESCRIPTION OF THE DRAWINGS

The accompanying drawings constitute a part of this specification and illustrate embodiments of the subject matter disclosed herein.

FIG. 1 shows an e-commerce platform, according to an embodiment.

FIG. 2 shows a home page of an administrator, according to an embodiment.

FIG. 3 shows the e-commerce platform having a sales regulation engine, according to an embodiment.

FIG. 4 shows components of a system, according to an embodiment.

FIG. 5 shows execution steps for applying multiple levels of bot detection, according to an embodiment.

FIG. 6 shows a flow chart having operations for applying multiple levels of bot detection, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

A bot detection system or software can detect bots attempting to access and initiate purchases from merchant webpages. To detect bots, a security server (or any other host server) receives and evaluates signals that are received during sessions between end-user customer devices and the merchant webpage. The signals are attributes or characteristics that are identified or derived from the payload data (e.g., content data, protocol data, metadata) and/or header data of the data packets exchanged during a session. The bot detection system assigns scores to each signal. If a set of scores exceed a bot detection threshold score, then the security server determines the actor operating the customer device is a bot rather than a human.

Given the heightened concerns over bots hoarding sales inventory during a flash sale as well as bot developers testing bot detection algorithms during the flash sale, the bot detection system could be employed for only the duration of the flash sale. Bot detection techniques, including the signals being evaluated, could be randomized, pseudo-randomized, or merely adjusted to create obfuscation challenges to bot-adaptations. In an attempt to avoid circumvention of the bot detection algorithm, it may be desirable to limit the use of the bot detection algorithm to use only during the flash sale.

To prevent hoarding and establish an honest opportunity for human customers to make purchases, heightened bot detection (a primary level) may be implemented at the beginning of a flash sale. The bot detection may then be scaled back to a secondary level after some period of time or at a particular time. Detection can be scaled back in the secondary level in a number of ways, e.g., by evaluating a smaller set of signals, evaluating the same set of signals against a higher bot detection threshold or using a lower scoring against the same threshold used the primary level of detection. Most purchase activity is front-loaded towards the beginning of the flash sale. In one configuration, lowered bot detection standards could be employed towards the end of the flash sale, for example, to ease processing requirements and limit false positives. The shift in the level of detection may be sufficient to complicate bot testing and adaptations.

The detection level automatically transitions to the secondary level at the end of the event. In one configuration, the secondary level can evaluate fewer signals than the primary level used during the flash sale. The secondary level can also vary from the primary level by using a higher threshold score or by adjusting the signal scoring to produce scores that are less likely to exceed the threshold.

The bot detection system can use historical records and vendor data to predict the expected length of the flash sales event (e.g., how quickly all of the inventory will sell), at which point the system can scale back protection. The two-level (or multi-level) detection approach allows for time-bound bot detection, keeping the more comprehensive protection targeted to the main or initial sales event. It may be acceptable to employ the secondary level security when there is no more inventory (e.g., a restock). The server can implement a primary level of bot detection at the start of a flash sale and reduce the bot detection to a secondary level of protection at the predicted time that corresponds to a sale length, complete initial sale of the product, or some predefined expiry point. The system can utilize the predicted end of the flash sale to vary the length of time using the heightened bot detection to increase unpredictability for bot developers. For example, the second level of security can be applied at an amount of time before or after the predicted end time. The offset amount of time can also be randomized. As an alternative, the system can use a fixed predetermined time period for each flash sale (e.g., 4 minutes, 5 minutes, 6 minutes). As another alternative to a prediction, the bot detection level can automatically change based upon a remaining quantity of inventory (e.g., transition from primary level to secondary level when an item is sold out).

In some embodiments, the system can employ what is effectively a “honey pot” scheme during the flash sale. The flash sale is often a target for bot activity, so it is assumed that bots will swarm the merchant webpage. This is a natural honey pot. At the transition to a different level of bot detection, a number of bots will be exposed. The header data from the packets from the bots can be evaluated to identify their source.

### I. Example E-Commerce Platform

In some embodiments, the methods disclosed herein may be performed on or in association with a commerce platform, such as an e-commerce platform. Therefore, an example of a commerce platform will be described by way of introduction.

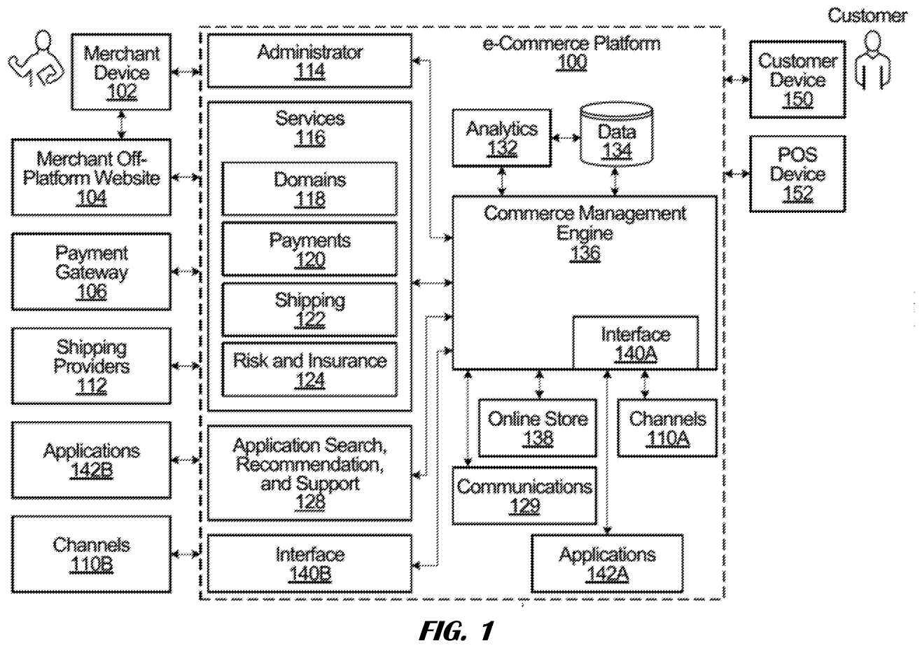

FIG. 1 illustrates an e-commerce platform 100, according to an illustrative system embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the e-commerce platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other interne or web property or asset supported by or on behalf of the merchant separately from the e-commerce platform 100), and the like. However, even these ‘other’ merchant commerce facilities may be incorporated into the e-commerce platform 100, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms of online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The web browser (or other application) of the customer device 150 then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their web site through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data facility 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

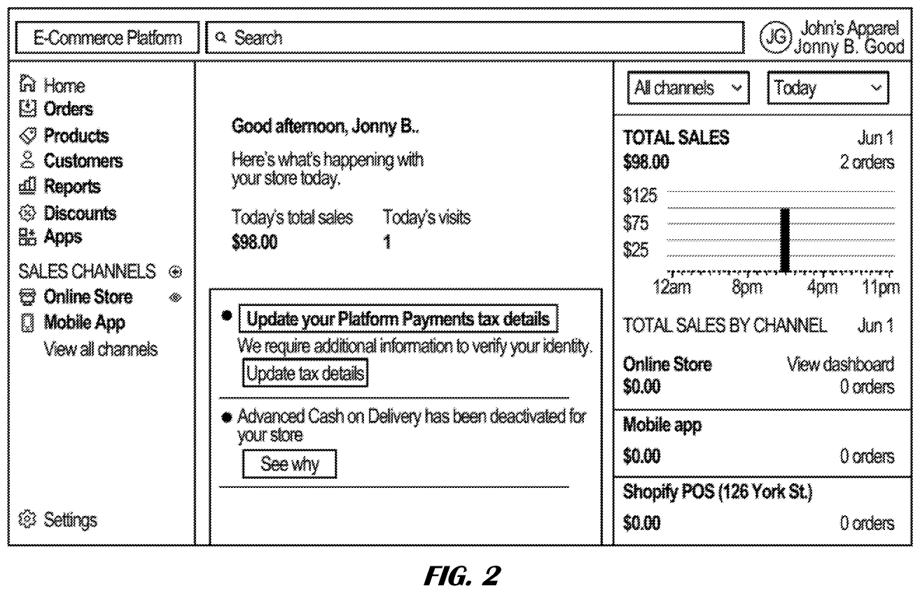

FIG. 2 depicts a non-limiting embodiment for a home page of a merchant administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store 138, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the merchant device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the e-commerce platform 100 or by a different party. In some embodiments, an application 142B may be provided by the same party providing the e-commerce platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the e-commerce platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the e-commerce platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension or API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Example System Embodiment for Regulating Flash Sales

Regulating product flash sales of a merchant webpage can be implemented for various reasons. For example, a merchant may regulate the sales of a product for the purpose of: ensuring that all customers have an equal opportunity to purchase the product; inhibiting a customer from purchasing more than one item of the product; inhibiting customers from automating the purchase of the product using computer applications (e.g., bots); and giving loyal customers (for example, customers that have shopped with the merchant before) priority to purchase the product.

Allowing human customers an opportunity to purchase products can be particularly acute when the merchant is conducting a flash sale for a certain product, which often provides a sale of limited inventory. These flash sales can be timed (e.g., having a scheduled start time and/or end time) or end when the inventory of the product has emptied or a defined quantity of inventory remains. The speed at which bots can operate (e.g., place purchases) allows bots to purchase a large amount or the entire inventory of the on-sale product before human customers have had an opportunity to purchase the product.

To detect and/or mitigate undesirable bot activity during flash sales, bot detection algorithms analyze web traffic from customer devices for various indicators of the type of actor operating a customer device: a human or a bot. Bot developers can quickly adjust the operational behaviors of bots, so it can be beneficial to vary the bot detection algorithms employed. Typically, bot activity occurs within the first few minutes of the flash sale. As such, the bot detection algorithm can be varied after some pre-configured or dynamically determined period of time. In some cases, it may be useful to vary the bot detection algorithm being employed based upon the amount of product inventory remaining or the rate at which the product is being sold. For example, the product may be selling at a rate that the product will sell out prior to a predetermined time to change from a first bot detection algorithm to a second bot detection algorithm. In this example, the second bot detection algorithm could be employed when there is some amount of inventory remaining, before reaching the predetermined time to change from the first bot detection algorithm to the second bot detection algorithm.

It should be appreciated that embodiments may implement any number of bot detection algorithms. It should be further appreciated that embodiments may implement any number of the triggering instructions for employing each bot detection algorithm without departing from this disclosure. Non-limiting examples of such triggering instructions may include a pre-configured or dynamically determined time, a pre-configured or dynamically determined inventory condition or threshold, and user inputs, among others.

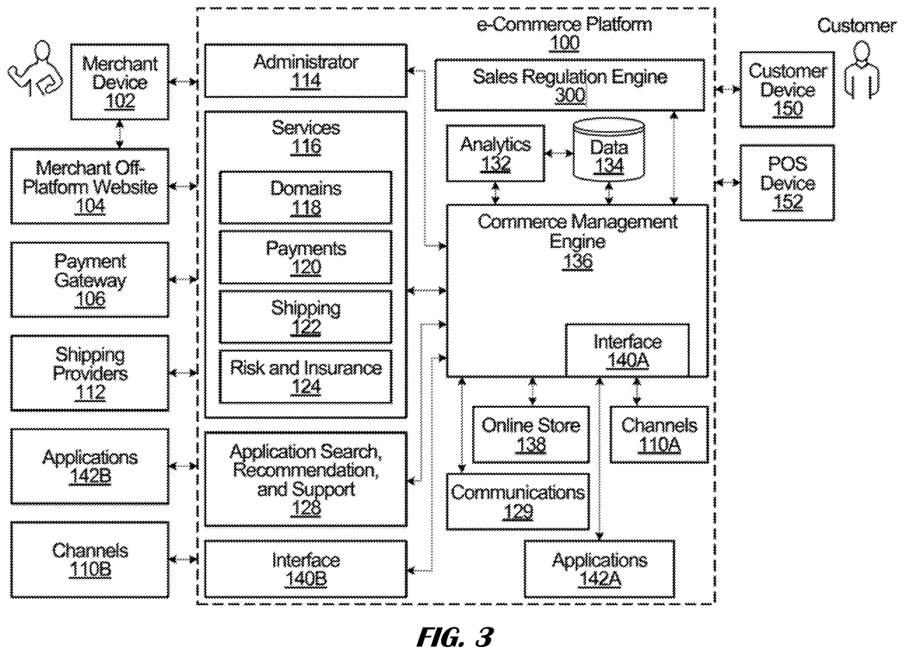

FIG. 3 illustrates the e-commerce platform 100 of FIG. 1, but now includes a sales regulation engine 300, which may be an implementation of a bot detection system or software. The sales regulation engine 300 is an example of a computer-implemented system that can manage, regulate and/or control sales of any or all products on the e-commerce platform 100. In some implementations, the sales regulation engine 300 regulates the sales of products in the online store 138. Regulating the sales of a product can include, without limitation: regulating which customers can purchase a product; regulating when a customer can purchase the product; regulating how quickly a customer can purchase the product; and regulating how many items of the product a customer can purchase.

Although the sales regulation engine 300 is illustrated as a distinct component of the e-commerce platform 100 in FIG. 3, this is only an example. The sales regulation engine 300 could also or instead be provided by another component residing within or external to the e-commerce platform 100. In some embodiments, a sales regulation engine is integrated with the online store 138. In some embodiments, either or both of the applications 142A-B provide a sales regulation engine that is available to merchants. Furthermore, in some embodiments, the commerce management engine 136 provides a sales regulation engine 300. The e-commerce platform 100 could include multiple sales regulation engines 300 that are provided by one or more parties. The multiple sales regulation engines 300 could be implemented in the same way, in similar ways and/or in distinct ways. In addition, at least a portion of a sales regulation engine 300 could be implemented in the merchant device 102. For example, the merchant device 102 could store and run a sales regulation engine 300 locally as a software application.

As discussed in further detail below, the sales regulation engine 300 could implement at least some of the functionality described herein. Although the embodiments described below may be implemented in association with an e-commerce platform, such as (but not limited to) the e-commerce platform 100, the embodiments described below are not limited to e-commerce platforms 100. For example, online stores and/or sales regulation engines 300 may be implemented independent of an e-commerce platform.

The sales regulation engine 300 may monitor and disrupt undesirable bot activity for a merchant's online store 138 hosted on the e-commerce platform 100. The sales regulation engine 300 may be configured to ingest and analyze information received from customer devices 150 to determine the likelihood that a customer device 150 is executing a bot. The sales regulation engine 300 can apply bot detection algorithms to signals that are defined by various types of information. Each bot detection algorithm is configured to analyze a certain set of signals to determine whether an actor driving the operations of the customer device 150 is a human or a bot. Non-limiting examples of signals may include: source addresses (e.g., IP address, MAC addresses) and source device types, and the types and sufficiency of data in data packets. Non-limiting examples of bot detection algorithms evaluating these signals may include: determining whether the customer device 150 is accessing the e-commerce platform 100 via an address that is known to be an external proxy server; and determining whether the data packets from the customer device 150 are missing expected payload data in an API call, as is expected to occur from a bot.

### II. Example Networked Components of System

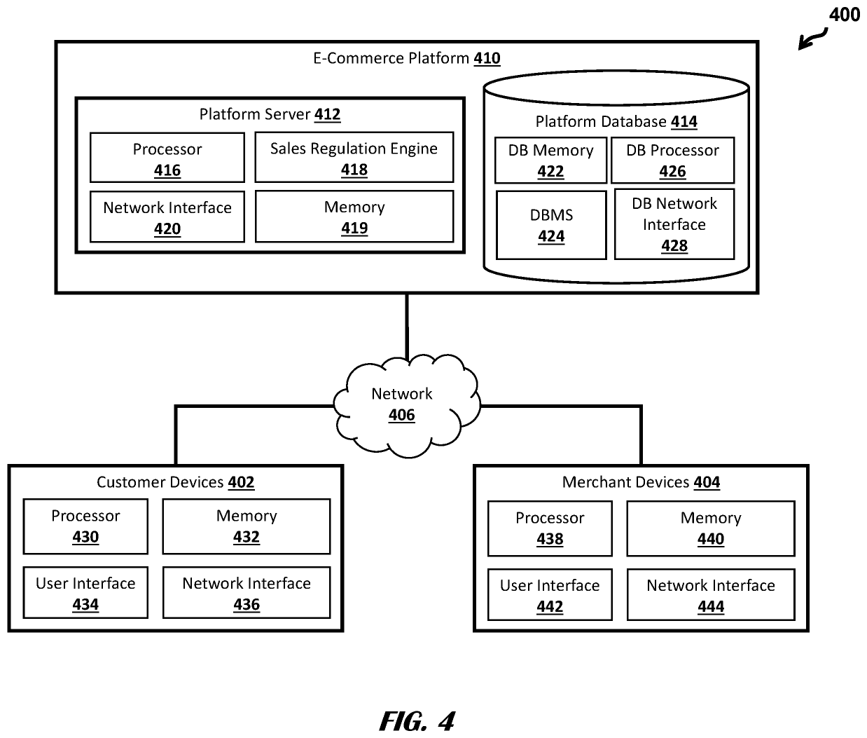

FIG. 4 shows components of a system 400, according to an embodiment. The system 400 includes user devices 402 and merchant devices 404 to connect with an e-commerce platform 410 via one or more networks 406. The illustrative system 400 is described and shown in FIG. 4 as having one of each component for ease of description and understanding of an example. It should, however, be appreciated that embodiments may include any number of the components described herein. It should be further appreciated that embodiments may comprise additional or alternative components, or may omit certain components, and still fall within the scope of this disclosure.

The network 406 may include any number of networks, which may be public and/or private networks. The network 406 may comprise hardware and software components implementing various network and/or telecommunications protocols facilitating communications between various devices, which may include devices of the system 400 or any number of additional or alternative devices not shown in FIG. 4. It should be appreciated that the network 406 may be implemented as a cellular network, a Wi-Fi network, or other wired local area network (LAN) or wireless LAN, a WiMAX network or other wireless or wired wide area network (WAN), and the like. The network 406 may also communicate with external servers of other external services coupled to the network 406, such as servers hosting a social media platform or a banking platform.

The network 406 may include any number of security devices or logical arrangements (e.g., firewalls, proxy servers, DMZs) to monitor or otherwise manage web traffic to the e-commerce platform 410. Security devices may be configured to analyze, accept, or reject incoming web requests from user devices 402 or merchant devices 404. In some embodiments, a security device may be a physical device (e.g., a firewall). A security device may be a software application (e.g., Web Application Firewall (WAF)) that is hosted on, or otherwise integrated into, another computing device of the system 400. The security devices monitoring web traffic are associated with, and administered by, the e-commerce platform 410.

Merchant devices 404 are electronic devices associated with merchant accounts of the e-commerce platform 410. Customer devices 402 are electronic devices associated with users who are not operating as merchants, such as end-point customers or potential customers, who are visiting online stores of merchants on the e-commerce platform 410. It should be appreciated that, in some circumstances, a customer device 402 and a merchant device 404 can be the same device, as merchants may sometimes navigate webpages for online stores of the e-commerce platform 410 when the merchant is acting in the capacity of a customer. As such, a user device 402 may sometimes act as a merchant device 404 while at other times act as a user device 402. In an example, a merchant may use the same device to both configure the merchant settings for the online store (or other configuration settings) and then browse the online stores of other merchants on the e-commerce platform 410.

The customer devices 402 and the merchant devices 404 may be any electronic device comprising hardware and software components capable of performing the various tasks and processes described herein. Non-limiting examples of the user devices 402 and the merchant devices 404 include mobile phones, tablets, laptops, and personal computers, among others. When communicating with components of the e-commerce platform 410, user devices 402 and merchant devices 404 may generate web traffic that is processed by or otherwise accessible to one or more platform servers 412 of the e-commerce platform 410. The web traffic comprises data packets that includes various types of data that can be parsed, analyzed, or otherwise reviewed by various programmatic algorithms of the platform servers 412.

When a customer device 402 visits an online store of a merchant, the platform server 412 of the e-commerce platform 410 serves a webpage for the online store to the customer device 402. A browser or other application of the customer device 402 transmits a request to the e-commerce platform 410 for the webpage for the online store of the merchant. The platform server 412 may receive the request for the webpage from the browser or other application of the customer device 402, where the browser (or other application) connects the customer device 402 to the platform server 412 using an IP Address obtained by translating a domain name. In return, the platform server 412 transmits the requested webpage hosting the online store of the merchant for display on a customer user interface 434, such as a graphical user interface (GUI), of the customer device 402.

The customer device 402 may be a mobile phone, tablet, laptop or computer owned and/or used by a customer. The customer device 402 includes a customer processor 430, customer memory 432, customer user interface 434, and customer network interface 436. An example of a customer user interface 434 is a display screen (which may be a touch screen), a gesture recognition system, a keyboard, a stylus, and/or a mouse. The customer network interface 436 is provided for communicating over the network 406. The structure of the customer network interface 436 will depend on how the customer device 402 interfaces with the network 406. For example, if the customer device 402 is a mobile phone or tablet, the customer network interface 436 may include a transmitter/receiver with an antenna to send and receive wireless transmissions to/from the network 406. If the customer device 402 is a personal computer connected to the network 406 with a network cable, the customer network interface 436 may include, for example, a NIC, a computer port, and/or a network socket. The customer processor 430 directly performs or instructs all of the operations performed by the customer device 402. Non-limiting examples of these operations include processing user inputs received from the customer user interface 434, preparing information for transmission over the network 406, processing data received over the network 406, and instructing a display screen to display information. The customer processor 430 may be implemented by one or more processors that execute instructions stored in the customer memory 432. Alternatively, some or all of the customer processor 430 may be implemented using dedicated circuitry, such as an ASIC, a GPU, or a programmed FPGA.

The merchant device 404 may be a mobile phone, tablet, laptop, or computer used by a merchant. The merchant device 404 includes a merchant processor 438, merchant memory 440, a merchant user interface 442, and a merchant network interface 444. An example of a merchant user interface 442 is a display screen (which may be a touch screen), a keyboard, and/or a mouse. The merchant network interface 444 is provided for communicating over the network 406. The structure of the merchant network interface 444 will depend on how the merchant device 404 interfaces with the network 406. For example, if the merchant device 404 is a mobile phone or tablet, the merchant network interface 444 may include a transmitter/receiver with an antenna to send and receive wireless transmissions to/from the network 406. If the merchant device 404 is a personal computer connected to the network 406 with a network cable, the merchant network interface 444 may include, for example, a NIC, a computer port, and/or a network socket. The merchant processor 438 directly performs or instructs all of the operations performed by the merchant device 404. Examples of these operations include processing user inputs received from the merchant user interface 442, preparing information for transmission over the network 406, processing data received over the network 406, and instructing a display screen to display information. The merchant processor 438 may be implemented by one or more processors that execute instructions stored in the merchant memory 440. Alternatively, some or all of the merchant processor 438 may be implemented using dedicated circuitry, such as an ASIC, a GPU, or a programmed FPGA.

The e-commerce platform 410 is a computing system infrastructure owned and managed by an e-commerce service and, in some embodiments, may be the same as or similar to that described with reference to FIG. 1 and FIG. 3, though this need not be the case. The e-commerce platform 410 includes electronic hardware and software components capable of performing various processes, tasks, and functions of the e-commerce platform 410. For instance, the computing infrastructure of the e-commerce platform 410 may comprise one or more platform networks (not shown) interconnecting the components of the e-commerce platform 410. The platform networks may comprise one or more public and/or private networks and include any number of hardware and/or software components capable of hosting and managing the networked communication among devices of the e-commerce platform 410.

As shown in FIG. 4, the components of the e-commerce platform 410 include the platform server 412 and a platform database 414. However, it should be appreciated that embodiments may include additional or alternative components capable of performing the operations described herein. In some implementations, certain components of the e-commerce platform 410 may be embodied in separate computing devices that are interconnected via one or more public and/or private internal networks. In some implementations, certain components of the e-commerce platform 410 may be integrated into a single device. For instance, the platform server 412 may host the platform database 414. Furthermore, the e-commerce platform 410 may include any number of platform servers 412 (described further below) configured to serve various functions of the e-commerce platform 410. Non-limiting examples of such functions may include webservers hosting webpages on behalf of merchants (e.g., online stores), security servers executing various types of software for monitoring web traffic (e.g., sale regulation engine), and database servers hosting various platform databases 414 of the e-commerce platform 410, among others.

The illustrative e-commerce platform 410 of FIG. 4 is shown and described as having only one platform server 412 performing each of the various functions of the e-commerce service for ease of discussion. For instance, the platform server 412 is described as serving the functions of a security server (executing a sales regulation engine 418) and a webserver (hosting webpages for online stores and account administration). It should, however, be appreciated that FIG. 4 is merely illustrative and that embodiments are not limited to the description of system 400 or what is shown in FIG. 4. The software and hardware of the platform server 412 may be integrated into a single distinct physical device (e.g., a single platform server 412) or may be distributed across multiple devices (e.g., multiple platform servers 412). For example, some operations may be executed on a first computing device while other operations may be executed on a second computing device, such that the functions of the platform server 412 are distributed among the various computing devices. In some implementations, the platform server 412 may be a virtual machine (VM) that is virtualized and hosted on computing hardware configured to host any number of VMs.

The platform database 414 stores and manages data records concerning various aspects of the e-commerce platform 410, including information about, for example, actors (e.g., merchants, consumers, platform administrators), electronic devices, merchant offerings (e.g., products, inventory, services), various metrics and statistics, machine-learning models, merchant pages hosting merchant stores, and other types of information related to the e-commerce platform 410 (e.g., usage, security, and services). The platform database 414 may be hosted on any number of computing devices having a processor (sometimes referred to as a database (DB) processor 426) and non-transitory machine-readable memory configured to operate as a DB memory 422, and capable of performing the various processes and tasks described herein. For example, one or more platform servers 412 may host some or all aspects of the platform database 414.

A computing device hosting the platform database 414 may include and execute database management system (DBMS 424) software, though a DBMS 424 is not required in every potential embodiment. It should be appreciated that the platform database 414 can be a single, integrated database structure or may be distributed into any number of database structures that are configured for some particular types of data needed by the e-commerce platform 410. For example, a first database could store user credentials and be accessed for authentication purposes, and a second database could store raw or compiled machine-readable software code (e.g., HTML, JavaScript) for webpages such that the DB memory 440 is configured to store information for hosting webpages.

The computing device hosting the platform database 414 may further include a DB network interface 428 for communicating via platform networks of the e-commerce platform 410. The structure of the DB network interface 428 will depend on how the hardware of the platform database 414 interfaces with other components of the e-commerce platform 410. For example, the platform database 414 may be connected to the platform network with a network cable, the DB network interface 428 may include, for example, a network interface card (NIC), a computer port, and/or a network socket. The DB processor 426 directly performs or instructs all of the operations performed by the platform database 414. Non-limiting examples of such operations include processing queries or updates received from platform servers 412, customer devices 402, and/or merchant devices 404; preparing information for transmission via the platform network and/or the external networks 406; and processing data received via the platform network and/or the external networks 406. The DB processor 426 may be implemented by one or more processors that execute instructions stored in the DB memory 422 or other non-transitory storage medium. Alternatively, some or all of the DB processor 422 may be implemented using dedicated circuitry, such as an ASIC, a GPU, or a programmed FPGA.

The DB memory 422 of the platform database 414 may contain data records related to, for example, merchant flash sale events, consumer activity, and various information and metrics derived from web traffic involving user devices 402. The data may be accessible to platform servers 412. The platform servers 412 may issue queries to the platform database 414 and data updates based upon, for example, merchant transaction records or instructions received from the servers of third-party services (e.g., banking servers). In some cases, the platform database 414 may store data received from customer devices 402 or merchant devices 404. For example, a merchant can use a merchant administration webpage or other user interface to schedule a flash sale for the merchant's online store. In this example, the merchant's inputs are received at a platform server 412 hosting the administration webpage, and the platform server 412, in turn, updates the data records for the merchant in the platform database 414 to reflect the newly scheduled flash sale event associated with the merchant webpage hosting the merchant online store.

The platform server 412 may be any computing device that comprises a server processor 416 and non-transitory machine-readable storage media (e.g., server memory 419) and that is capable of executing the software for one or more functions, such as a sales regulation engine 418. In some cases, the server memory 419 may store or otherwise contain the computer-executable software instructions, such as the sales regulation engine 418. The software and hardware components of the platform server 412 enable the platform server 412 to perform various operations that serve particular functions of the e-commerce platform 410. For example, the platform server 412 that serves as a webserver may execute various types of webserver software (e.g., Apache®, Microsoft IIS®). As another example, the platform server 412 that serves as a security server may execute software for monitoring and analyzing web traffic between user devices 402, merchant devices 404, and the e-commerce platform 410. It should be appreciated that these are merely examples and not intended to be limiting as to the potential arrangements or functions of the platform servers 412. Non-limiting examples of the platform server 412 may include desktop computers, laptop computers, and tablet devices, among others.

The platform server 412 may execute a sales regulation engine 418 that detects bots attempting to access a flash sale event associated with a particular merchant webpage hosting an online store of the merchant. In operation, the platform server 412 may capture and analyze web traffic of customer devices 402 to identify whether any customer devices 402 are executing a bot to access an online store of the e-commerce platform 410. The web traffic comprises data packets having header data fields and payload data (e.g., content data, metadata) that can be parsed and/or analyzed for various types of information. The platform server 412 may identify or extract particular types of data from the data packets to detect bots.

The sales regulation engine 418 supports the regulation of product sales in an online store or any other service platform for selling products. The location of the sales regulation engine 418 is merely an example. The sales regulation engine 418 may be provided, at least in part, by the platform server 412 hosting the particular online store; or may be an application or service of any other platform server 412 that is supported by or in communication with the platform server hosting the online store. Additionally or alternatively, the sales regulation engine 418 could be provided by the e-commerce platform 410 as a separate web-based or cloud-based service. In the system 400, the sales regulation engine 418 corresponds to the sales regulation engine 300 in the e-commerce platform 100 of FIG. 3 and is hosted on the platform server 412 of the e-commerce platform 410. In some implementations, the sales regulation engine 418 is implemented at least in part by a user device, such as a merchant device. Other implementations of the sales regulation engine 418 are also contemplated, such as a stand-alone service to regulate product sales. While the sales regulation engine 418 is shown as a single component of the e-commerce platform 410, the sales regulation engine 418 could be provided by multiple different components that are in networked communication with the platform server 412 executing the sales regulation engine 418.

The sales regulation engine 418 (or other software of the platform server 412) executes bot detection algorithms that analyze the web traffic of the user devices 402. When a flash sale occurs, the platform server 412 sequentially applies multiple bot detection algorithms to the online store webpage for the merchant conducting the flash sale. Each bot detection algorithm evaluates signals in the web traffic associated with user devices 402 accessing the merchant webpage. The signals are attributes or characteristics of actors that are based on various types of information found in data packets received from a user device 402. In some cases, signals include information that is explicit in a data packet, which may be in the header data (e.g., IP address of a customer device 402) or the content of the payload data (e.g., customer account ID) of the data packet. And in some cases, signals include information that is derived from the data packets by the platform server 412 or other device of the system 400, such as the speed or frequency at which the user device 402 interacts with various elements of the merchant webpage.

The platform server 412 executing bot detection algorithms can determine a bot score for one or more signals, which are associated with customer devices 402. The platform server 412 assigns or otherwise associates the one or more bot scores to the particular customer device 402. In some implementations, the bot detection algorithm may determine an overall bot score based on the bot scores and assign the overall bot score to the user device 402. Each bot score indicates a likelihood that an actor driving the operations of the user device 402 is a bot. The bot detection algorithm then compares the bot score assigned to the user device 402 against a bot detection threshold value. The platform server 412 determines that the actor is likely a bot when the bot score satisfies the bot detection threshold. As mentioned, the platform server 412 applies multiple bot detection algorithms to a merchant page during a flash sale event, where each bot detection algorithm can be configured to evaluate various sets of signals.

In some embodiments, the bot detection algorithms can represent different “levels” of security or scrutiny. Increased levels of bot detection algorithms may be accomplished by, for example, analyzing a larger set of signals (e.g., more parameters), analyzing a set of signals that are more likely to satisfy the bot detection threshold (e.g., lower threshold parameters), and/or establishing the bot detection threshold to be a value that is more likely to be satisfied by bot scores. For example, in some cases, a lower-level bot detection algorithm evaluates a subset of the signals evaluated by a higher-level bot detection algorithm.

In some embodiments, the platform server 412 executes a bot detection algorithm but the bot detection algorithm does not analyze any signals (analyze zero signals), such that bot detection is effectively “turned-off.” This change to analyze no signals can occur at some point during or after the flash sale. A merchant may instruct the platform server 412 to apply a zero signal bot algorithm at some time point during the flash sale and/or in response to certain conditions, such as an amount of inventory remaining or the rate of sales, or any other trigger (described further below). As an example, in some circumstances, a merchant may determine that there is too much remaining inventory at some point near the end of the flash sale, and it would be acceptable to allow bots to place purchases in order to receive some revenue. In this example, the merchant may schedule the zero signal bot algorithm to be applied during the flash sale, based on an amount of inventory remaining.

Any number of triggering events or instructions may be implemented when configuring the platform server 412 when to apply certain bot detection algorithms. The platform server 412 may detect or receive triggering events or instructions that instruct the platform server 412 when to apply each of the bot detection algorithms. The triggering events may cause the platform server 412 to apply bot detection algorithms according to dates or times, based on certain conditions, or in response to instructions received from an end-user (e.g., merchant, platform administrator) via a graphical user interface (GUI). A triggering instruction may be, for example, a software instruction triggered by a scheduled event, an input received from an end-user via the GUI, or a software instruction triggered by detecting a certain data condition (e.g., predicted time that inventory is emptied). The platform server 412 may be in communication with or host the platform database 414 that contains various types of merchant data associated with the merchant webpages. The merchant data in the DB memory 422 may include, for example, an indication of a scheduled flash sale event, a product associated with the flash sale, the inventory of the product, and other information about the product or the merchant. The platform server 412 may apply each of the bot detection algorithms in response to the platform server 412 receiving instructions and/or identifying certain data values in the merchant data (e.g., a scheduled time period, an amount of inventory).

In some implementations, the platform server 412 may apply bot detection algorithms based on time. The platform server 412 may apply the first bot detection algorithm in response to determining or being instructed that the flash sale has begun, as indicated by the relevant merchant data. In some cases, the platform server 412 may apply the first bot detection algorithm for a specified period of time, then apply a second bot detection algorithm. In some cases, the platform server 412 may determine a time to apply the second bot detection algorithm relative to a scheduled time period or end time of the flash sale indicated by the merchant data. For instance, the platform server 412 may identify the scheduled time period of the flash sale, then apply the second bot detection algorithm at some point in time prior to end of the flash sale.

Additionally or alternatively, the platform server 412 may apply bot detection algorithms according to certain triggering conditions in the merchant data or other types of data. As an example, the platform server 412 applies the first bot detection algorithm upon detecting a start of a scheduled flash sale event in the merchant data. In this example, the platform server 412 is configured to monitor the available inventory of the product as indicated by the merchant data, applying the second bot detection algorithm in response to determining that the inventory has dropped below a threshold amount.

In an example, the platform server 412 can apply a first bot detection algorithm (a lower level bot detection algorithm) at or near a start of a scheduled flash sale event, apply a second bot detection algorithm (a higher level bot detection algorithm) during the flash sale event, and apply the first bot detection algorithm near the end of the flash sale event or at the end of the flash sale event. In another example, the platform server 412 does not apply a bot detection algorithm at or near a start of a scheduled flash sale event, then applies a bot detection algorithm during the flash sale event, and then stops the application of the bot detection algorithm near the end of the flash sale event or at the end of the flash sale event. In yet another example, the platform server 412 can apply a first bot detection algorithm using zero signals of a set of signals at or near a start of a scheduled flash sale event, apply a second bot detection algorithm applying more than zero signals of the set of signals during the flash sale event, and apply the first bot detection algorithm near the end of the flash sale event or at the end of the flash sale event.

As another example, the platform server 412 monitoring the inventory may predict an end of the flash sale, e.g., when the inventory has all been sold. The platform server 412 may calculate the rate at which the product is being sold, such that the predicted end of the sale is a time value or an inventory amount based on the rate of sales relative to the amount of inventory remaining. In this example, the platform server 412 may implement the predicted end of the flash sale as a threshold value for determining when to apply the second bot detection algorithm (e.g., a lower level bot detection algorithm). For instance, the platform server 412 may determine a predicted time or a predicted inventory amount to apply the second bot detection algorithm based on the rate of sale. The platform server 412 may be configured to determine the predicted end of the sale at a specified time or at specified amount of remaining inventory. In some cases, the platform server 412 may update the predicted end of the sale at a specified interval or at specified inventory amounts.

In some embodiments, the e-commerce platform 410 can, in effect, act as a honeypot for bots during the flash sale while employing the subject matter of the present applications. Flash sales are often a target for bot activity, so it is likely that bots will swarm a merchant webpage conducting a flash sale. As such, a merchant webpage conducting the flash sale is a natural honey pot. When the platform server 412 transitions from one bot detection algorithm to another, a number of bots will be exposed. The platform server 412 (or other device of the system 400) can be configured to evaluate the payload data (e.g., content data, metadata) and/or header data of the data packets received from the bots can be evaluated to identify each source.

When the platform server 412 (or other device) functions as a honeypot, the platform server 412 monitors, tracks, and/or identifies information about actors who develop and employ bots and/or user devices 402 for each user device 402 determined to be executing a bot. The bot information can be any type of data extracted and/or derived from the header data or payload of data packets received from the user device 402, such as the information used for one or more of the signals.

When functioning as a honeypot, the platform server 412 may determine certain characteristics about the source of a bot detected by the platform server 412. Non-limiting examples may include device IDs (e.g., MAC address, device IP address) and geographical sources (e.g., device IP address, upper-level IP addresses, geo-location IP headers), among others. Additionally or alternatively, the platform server 412 may begin logging the web traffic from the customer device 402 and the behavior aspects of the bot executed by the customer device 402. While ordinary network and security devices (e.g., firewalls, routers) routinely log web traffic, in some implementations logged information for a honeypot embodiment may be stored in a particular portion of the DB memory 422 of the platform database 414 for later data mining and pattern recognition operations.

In some embodiments, the platform server 412 may continue to operate as a parallel or alternative platform of the e-commerce platform 410. Honeypots typically mimic the experience and/or operations of production environments, in order to fool bad actors to continue operating as though still undetected. When the platform server 412 detects a bot is accessing a flash sale, the platform server 412 may redirect the web traffic for the customer device 402 associated with the bot. The web traffic can be redirected to the platform server 412 that hosts a parallel experience to the production e-commerce platform 410 and online store. The platform server 412 may end the networked session with customer device 402 at some point prior to an actual purchase being executed between the merchant and the bot.

### III. Methods of Multi-Level Bot Detection

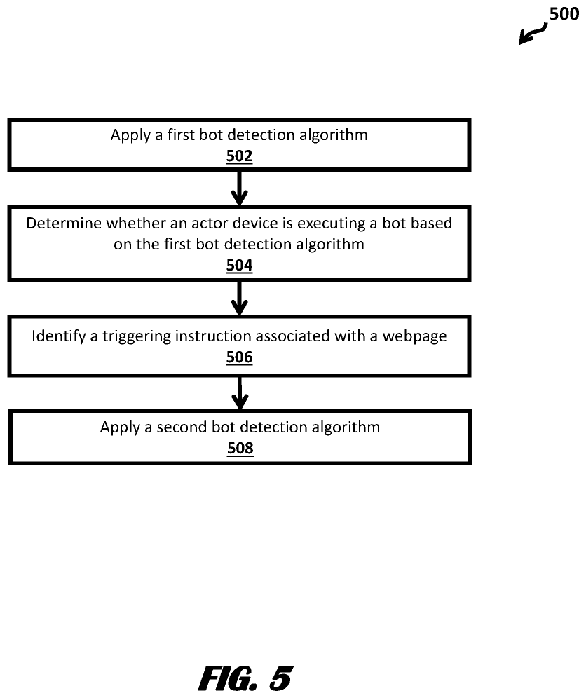

FIG. 5 shows a method 500 for applying multiple levels of bot detection, according to an embodiment. A server or other computing device of an e-commerce platform (e.g., a platform server) may include software components or other machine-readable instructions (e.g., sales regulation engine) that instruct the server to execute the steps of the method 500.

The steps of the method 500 are described as being executed by a server of an e-commerce platform, but any number of additional or alternative devices may execute some or all of the steps and still fall within the scope of this disclosure. Although the illustrative method 500 is described as implementing a “first bot detection algorithm” and a “second bot detection algorithm,” it should be appreciated that this is merely for ease of understanding and description. Any number of bot detection algorithms may be implemented. It should be further appreciated that, although the bot detection algorithms of the method 500 are described as having decreasing “levels” of security or scrutiny, other embodiments may implement multiple bot detection algorithms having comparable levels, varying the types of information to be analyzed.

In step 502, a server of an e-commerce platform applies a first bot detection algorithm to a webpage for an online store of a merchant hosting a flash sale. The server may apply the first bot detection algorithm in response to detecting a triggering instruction, which could be, for example, detecting a scheduled time for the flash sale, or a user input received from a merchant device to begin the flash sale.

When applying the first bot detection algorithm, a set of signals associated with user devices accessing the flash sale and exchanging web traffic with the e-commerce platform. As mentioned, the server may parse or otherwise analyze the data in data packets received from customer devices. The customer devices accessing the flash sale event conducted by the merchant will transmit requests for the particular webpage containing the online store and hosting the flash sale. The server parses the various types of network traffic, and the first bot detection algorithm analyzes the various types of data corresponding to the particular signals evaluated by the first bot detection algorithm.

In step 504, the server determines whether an actor device (e.g., customer device) is executing a bot based on the first bot detection algorithm. As mentioned, user devices may implement bots to automate certain interactions with the online store. Bot detection algorithms can determine a likelihood that online purchase requests are generated by a bot.

In step 506, the server identifies a triggering instruction associated with the webpage hosting the online store. The triggering instruction could be, for example, detecting an established or dynamically determined time period for applying the first bot detection algorithm, an established or dynamically predicted end of the sale (e.g., inventory threshold), a user input received from a merchant device or administrator device to apply to the second bot detection algorithm, or any other condition or instruction that can trigger the server to apply the second bot detection algorithm.

In step 508, the server applies a second bot detection algorithm. When applying the second bot detection algorithm, the server begins evaluating a second set of signals associated with user devices accessing the flash sale and exchanging web traffic with the e-commerce platform. The second set of signals may include fewer signals than or different signals to the first set of signals evaluated by the first bot detection algorithm.

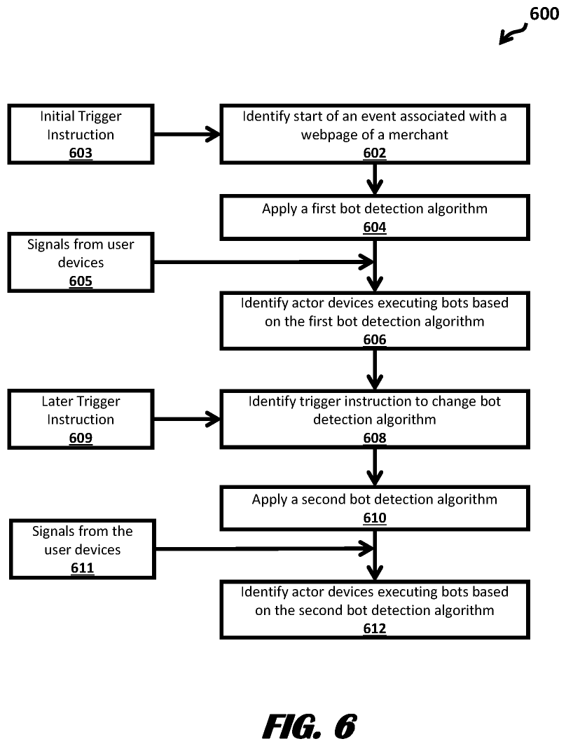

FIG. 6 is a flow chart showing operations of an illustrative method 600 for applying multiple levels of bot detection according to an embodiment. A server or other computing device of an e-commerce platform (e.g., a platform server) may include software components or other machine-readable instructions (e.g., sales regulation engine) that instruct the server to execute the steps of the method 600. For ease of description and understanding, the illustrative method 600 is described as being performed by a single server of an e-commerce platform, such as the platform server 412 described in FIG. 4, but may be performed by one or more processors of any number of computing devices.

It should be further appreciated that trigger instructions 603, 609 mentioned in method 600 may be in any form of machine-readable software instruction or data capable of triggering the server to perform certain tasks and processes described herein. It should be appreciated that the trigger instructions 603, 609 may be pushed to the server, fetched by the server, or be implemented as a configuration in code hosted by the server (e.g., configuration setting of the online store). In some cases, the trigger instructions 603, 609 may be sent to the server to cause the server to apply a certain bot detection algorithm. For example, another server or database may be configured to instruct the server to apply a bot detection algorithm according to an established or dynamically determined timing, such as a scheduled flash sale event or a dynamically determined time that the flash sale will end. As another example, the server may poll merchant data (e.g., calendar data, product inventory data) at a given interval to detect data conditions, such as the scheduled flash event, the amount of inventory remaining, or the rate of sales. A user (e.g., merchant, customer, platform administrator) may input, at least in part, trigger instructions 603, 609 that immediately or pre-configure settings that instruct the server to execute a particular bot detection algorithm at a certain time or in response to a certain data condition. It should be further appreciated that these examples of trigger instructions 603, 609 are non-limiting and that any combination of trigger instructions 603, 609 may be implemented.

In step 602, a server identifies a start of a flash sale event associated with an online store available at a merchant webpage, according to an initial trigger instruction 603. In this non-limiting example embodiment, the server may receive the trigger instruction 603 as a calendar event via one or more networks from a merchant device. The calendar event may then be stored into a database and any other related merchant data. The calendar event configures the server to launch the flash sale event at the scheduled time on a webpage hosting the merchant store.

In step 604, the server applies a first bot detection algorithm to a webpage associated with the flash sale, after detecting the initial trigger instruction 603. The server is configured to implement the first bot detection algorithm for a certain period time, which may be indicated by the initial trigger instruction 603 or until a later trigger instruction 609 is received. The first bot detection algorithm may be configured to evaluate a first set of signals 605 that correspond to or are defined by certain data values or information, where the data values or information may be extracted or derived from data packets by the server. As mentioned, the first bot detection algorithm determines and assigns one or more signal scores to each customer device based upon the one or more signals associated with the particular customer device.

In step 606, the server identifies actor devices executing bots based on the first bot detection algorithm according to a first set of signals 605 for the customer devices. During the flash sale event, the server may receive and analyze the data packets from any number of customer devices according to the first bot detection algorithm. The first bot detection algorithm determines whether the first set of signals 605 associated with customer devices indicate whether any customer device is operated by a human actor or a bot actor. The first bot detection algorithm determines and assigns one or more signal scores to each customer device based upon the one or more signals associated with the particular customer device. The server identifies that a customer device is being operated by a bot actor when the server determines that the one or more signal scores for that customer device (e.g., first actor device) satisfy a first bot detection threshold score.

In step 608, the server determines to change the bot detection algorithm associated with the online store available at the merchant webpage, according to a later trigger instruction 609. The later trigger instruction 609 instructs or otherwise causes the server to change to a second bot detection algorithm from the first bot detection algorithm. As mentioned, there may be any number of bot detection algorithms. There may be any number of instances that the server identifies or determines later trigger instructions 609 to change bot detection algorithms.

The server may be pre-configured to apply the first bot detection algorithm for a preset period of time. The later trigger instruction 609 may be a pre-configured setting associated with the online store, which may be inputted by the merchant user or a platform administrator. Additional or alternative types of later trigger instructions 609 may be implemented. For example, in some cases, the server determines the need to change to the bot detection algorithm based upon a threshold amount of inventory (e.g., a defined quantity of product) remaining or the rate of sales for the flash sale event. In such cases, the server may predict an end of the flash sale, where the later trigger instruction 609 is based upon the predicted end of the flash sale event relative to the rate of the sale. A second bot detection algorithm may then be applied at some time prior to the predicted end of the flash sale event.

In step 610, the server applies the second bot detection algorithm to a webpage associated with the flash sale. The server may implement the second bot detection algorithm for a certain period time or until the sale ends according to time or the inventory is exhausted. In the illustrative method 600, the second bot detection algorithm evaluates a second set of signals 611 that are a smaller subset of the first set of signals 605, thereby representing a lesser-degree (e.g., lower level) of bot protection. In some implementations, however, the second set of signals 611 may be different, though comparable, to the first set of signals 605. In some implementations, the second bot detection algorithm may not apply any signals (no signals used in the second set of signals 611). The second bot detection algorithm determines and assigns one or more signal scores to each customer device based upon the one or more signals associated with the particular customer device.

In step 612, the server identifies actor devices executing bots based on the second bot detection algorithm. During the flash sale event, the server may receive and analyze the data packets from any number of customer devices according to the second bot detection algorithm. The second bot detection algorithm determines whether the second set of signals 611 associated with customer devices indicate a likelihood that any customer device is operated by a human actor or a bot actor. As mentioned, the second bot detection algorithm determines and assigns one or more signal scores to each customer device based upon the one or more signals associated with the particular customer device. The server identifies that a customer device is being operated by a bot actor when the server determines that the one or more signal scores for that customer device (e.g., second actor device) satisfy a second bot detection threshold score. In some implementations, the second bot detection threshold for the second bot detection algorithm is comparable to the bot detection threshold applied by the first bot detection algorithm. And in some implementations, the second threshold for the second bot detection algorithm is comparatively lower/more difficult to satisfy than the bot detection threshold applied by the first bot detection algorithm.

In one embodiment, a computer-implemented method may include applying, by a computer, a first bot detection algorithm. The first bot detection algorithm may be configured to determine that an actor device is executing a bot. The method may further include identifying, by the computer, an event associated with a webpage. Responsive to identifying a triggering instruction associated with the event, a second bot detection algorithm may be applied by the computer.

In some implementations, the first bot detection algorithm may be applied to a first set of signals. Further, it may be that the second bot detection algorithm is applied to a second set of signals.

In some implementations, the second set of signals is a subset of the first set of signals.

In some implementations, the second set of signals consists of zero signals.

In some implementations, at least a portion of each set of signals is derived from data packets from the actor device.

In some implementations, the computer-implement method may further include determining, by the computer applying the first bot detection algorithm, that the actor device is executing the bot when a score for the first set of signals satisfies a threshold.

In some implementations, the computer-implement method may further include determining, by the computer applying the second bot detection algorithm, that a second actor device is executing one or more bots when a score for the second set of signals satisfies a threshold.

In some implementations, the computer-implement method may further include determining, by the computer applying the second bot detection algorithm, that a second actor device is executing a second bot when a score for the second set of signals satisfies a second threshold.

In some implementations, the triggering instruction is at least one of: an input from a customer device, a start time of an event associated with the webpage, and an end time of the event.

In some implementations, the computer-implement method may further include predicting, by the computer, an end time for an event associated with the webpage.

In some implementations, predicting the end time of the event may further include determining, by the computer, that an inventory will reach a defined quantity.

In some implementations, the event comprises a period of time for a sale of limited inventory.

In some implementations, the computer-implement method may further include identifying, by the computer, an actor using header data of data packets from the actor device in response to determining that the actor device is executing the bot.

In another embodiment, a system comprises a database including non-transitory machine-readable storage configured to store information for hosting a webpage; and at least one processor configured to: apply a first bot detection algorithm configured to determine that an actor device is executing a bot; identify an event associated with a webpage; and responsive to identifying a triggering instruction associated with the event, apply a second bot detection algorithm.

In some implementations, the first bot detection algorithm is applied to a first set of signals and wherein the second bot detection algorithm is applied to a second set of signals.

In some implementations, the second set of signals is a subset of the first set of signals.

In some implementations, the second set of signals consists of zero signals.

In some implementations, at least a portion of each set of signals is derived from data packets from the actor device.

In some implementations, the at least one processor, when applying the second bot detection algorithm, is configured to determine whether the actor device is executing one or more bots based on the applying of the second bot detection algorithm.

In some implementations, the triggering instruction is at least one of: an input from a user device, a start time of an event associated with the webpage, and an end time of the event.

In some implementations, the at least one processor is further configured to predict an end time for an event associated with the webpage.

In some implementations, the at least one processor, when predicting the end time of the event, is further configured to determine that an inventory will reach a defined quantity.

In some implementations, the event comprises a period of time for a sale of limited inventory.

In some implementations, in response to determining that the actor device is executing the bot, the at least one processor is further configured to identify an actor based upon header data of data packets from the actor device.

In yet another embodiment, machine-readable storage medium having computer-executable instructions stored thereon that, when executed by one or more processors, cause the one or more processors to perform operations comprising applying a first bot detection algorithm configured to determine that an actor device is executing a bot; identifying an event associated with a webpage; and responsive to identifying a triggering instruction associated with the event, applying a second bot detection algorithm.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A computer-implemented method comprising:
applying, by a computer, a first bot detection algorithm configured to determine that an actor device is executing a bot;
identifying, by the computer, an event associated with a webpage; and
responsive to identifying a triggering instruction associated with the event, applying, by the computer, a second bot detection algorithm configured to determine bot execution based upon a set of signals for accessing the webpage.

2. The computer-implemented method according to claim 1, wherein the first bot detection algorithm is applied to a first set of signals and wherein the second bot detection algorithm is applied to a second set of signals.

3. The computer-implemented method according to claim 2, wherein the second set of signals is a subset of the first set of signals.

4. The computer-implemented method according to claim 2, wherein the second set of signals consists of zero signals.

5. The computer-implemented method according to claim 2, wherein at least a portion of each set of signals is derived from data packets from the actor device.

6. The computer-implemented method according to claim 2, further comprising determining, by the computer applying the first bot detection algorithm, that the actor device is executing the bot when a score for the first set of signals satisfies a threshold.

7. The computer-implemented method according to claim 2, further comprising determining, by the computer applying the second bot detection algorithm, that a second actor device is executing one or more bots when a score for the second set of signals satisfies a threshold.

8. The computer-implemented method according to claim 2, further comprising determining, by the computer applying the second bot detection algorithm, that a second actor device is executing a second bot when a score for the second set of signals satisfies a second threshold.

9. The computer-implemented method according to claim 1, wherein the triggering instruction is at least one of: an input from a customer device, a start time of an event associated with the webpage, and an end time of the event.

10. The computer-implemented method according to claim 1, further comprising predicting, by the computer, an end time for an event associated with the webpage.

11. The computer-implemented method according to claim 10, wherein predicting the end time of the event further comprises: determining, by the computer, that an inventory will reach a defined quantity.

12. The computer-implemented method according to claim 10, wherein the event comprises a period of time for a sale of limited inventory.

13. The computer-implemented method according to claim 1, further comprising identifying, by the computer, an actor using header data of data packets from the actor device in response to determining that the actor device is executing the bot.

14. A system comprising:
a database including non-transitory machine-readable storage configured to store information for hosting a webpage; and
at least one processor configured to:
apply a first bot detection algorithm configured to determine that an actor device is executing a bot;
identify an event associated with a webpage; and
responsive to identifying a triggering instruction associated with the event, apply a second bot detection algorithm configured to determine bot execution based upon a set of signals for accessing the webpage.

15. The system according to claim 14, wherein the first bot detection algorithm is applied to a first set of signals and wherein the second bot detection algorithm is applied to a second set of signals.

16. The system according to claim 15, wherein the second set of signals is a subset of the first set of signals.

17. The system according to claim 15, wherein the second set of signals consists of zero signals.

18. The system according to claim 15, wherein at least a portion of each set of signals is derived from data packets from the actor device.

19. The system according to claim 16, wherein the at least one processor, applying the second bot detection algorithm, is configured to:
determine whether the actor device is executing one or more bots based on the applying of the second bot detection algorithm.

20. The system according to claim 14, wherein the triggering instruction is at least one of: an input from a user device, a start time of an event associated with the webpage, and an end time of the event.

21. The system according to claim 14, wherein the at least one processor is further configured to predict an end time for an event associated with the webpage.

22. The system according to claim 21, wherein the at least one processor, predicting the end time of the event, is further configured to:
determine that an inventory will reach a defined quantity.

23. The system according to claim 21, wherein the event comprises a period of time for a sale of limited inventory.

24. The system according to claim 14, wherein in response to determining that the actor device is executing the bot the at least one processor is further configured to:
identify an actor based upon header data of data packets from the actor device.

25. A non-transitory machine-readable storage medium having computer-executable instructions stored thereon that, when executed by one or more processors, cause the one or more processors to perform operations comprising:
applying a first bot detection algorithm configured to determine that an actor device is executing a bot;
identifying an event associated with a webpage; and
responsive to identifying a triggering instruction associated with the event, applying a second bot detection algorithm configured to determine bot execution based upon a set of signals for accessing the webpage.
